(19) United States
(12) Patent Application Publication
(10) Pub. No.: US 2007/0001035 A1
(43) Pub. Date: Jan. 4, 2007

(54) GPS guidance system for linear move irrigation apparatus

(75) Inventor: Luke J. Barker, Deshler, NE (US)

Correspondence Address: G. BRIAN PINGEL, BROWN, WINICK, GRAVES,;GROSS, BASKERVILLE AND SCHOENEBAUM, P.L.C., REGENCY WEST 5, 4500 WESTOWN PARKWAY, SUITE 277, WEST DES MOINES, IA, 50266, US

(73) Assignee: Reinke Manufacturing Company, Inc.

(21) Appl. No.: 11/170,667

(22) Filed: Jun. 29, 2005

(51) Int. Cl. A01G 27/00; B05B 3/18

(52) U.S. Cl. 239/723; 239/69

(57) ABSTRACT

A system for controlling the movement of a linear irrigation apparatus having a boom that is supported on at least two drive towers. The guidance system includes through at least one GPS signal receiving unit associated with one of the drive towers for the apparatus. The signal receiving unit has a GPS receiving antenna mounted from the drive tower so that it is in a position forwardly of a nonsteerable wheel for the tower. When the apparatus deviates from a desired path of travel, a drive relay is actuated to vary the actuation of the drive motors on the towers to return the apparatus to the desired path of travel.

### BACKGROUND OF THE INVENTION

1. Field of the Invention

The present invention relates in general to linear move irrigation systems for traversing an agricultural field along generally a straight line for providing water to the field, and more specifically relates to a guidance system utilized for controlling the travel of the irrigation system along a desired path.

2. Description of the Prior Art

Large scale movable irrigation systems with the elongated booms for supplying water to an agricultural field are most commonly found in two forms, either a center pivot system or a lateral move system commonly referred to as linear or inline machines. In the center pivot system, the boom is connected at one end to a pivot from which a supply of water is drawn and the boom is carried on a plurality of movable drive towers having nonsteerable drive wheels. The towers are driven in a circular path about the pivot and sprinklers spaced along the boom apply water to the field. Linear move irrigation systems also have an elongated boom that is supported by a plurality of movable towers. However in contrast to the center pivot systems the towers of the linear move system are usually driven along a straight line path that is perpendicular to the boom.

Although center pivot and linear irrigation systems are widely used throughout the United States and internationally and have performed generally well for their intended purpose, the linear move systems have a number of advantages over center pivot systems, which make them more convenient for use in many instances. For example, center pivot systems experience considerable difficulty in applying adequate quantities of water to the corner areas of square or rectangular fields in which they operate. Also, more water must be delivered to the outer end of the center pivot boom than to the portions near the pivot since the outer portions of the boom cover more surface area.

Linear move irrigation systems avoid the above problems, but in turn have disadvantages in their use. One of the principal disadvantages of linear move systems is the providing of an accurate system for guiding them as they traverse the fields in which they are utilized. A number of prior art alignment systems have been utilized in the past such as that shown in U.S. Pat. No. 3,608,826 which discloses a system for maintaining the irrigation boom in a straight condition, but does not necessarily result in the system moving along a desired straight path.

One type of guidance system for a linear move system that has been developed for guiding the boom along a desired path is disclosed in U.S. Pat. No. 4,463,906. Such system is designed to operate through the use of a plurality of magnetic elements that are buried in the field and are sensed by proximity switches on the drive towers to maintain the boom in alignment and moving along a desired path. A more recently developed guidance system that is not only utilized for linear move irrigation systems, but also for the swing arms of center pivot systems as well is the use of an electromagnetic buried cable in the field that is detected by sensing equipment on one of the drive towers and is utilized for guidance of the system.

Although buried cable systems have generally operated reasonably effectively, they suffer from the disadvantage of relying upon the use of the electromagnetic cable that must be buried in the ground and which occasionally breaks and requires expensive repairs to correct. Also, the use of the electromagnetic buried cable requires a one-time permanent installation so that it is difficult to move the desired path or lengthen the path because of the mechanical nature of the installation.

The present invention provides an improved system for the guidance of a linear move irrigation system and relies upon the use of a global positioning satellite network for obtaining relatively inexpensive but accurate guidance of linear move irrigation systems.

It is known in the art, to utilize global positioning satellite signals for controlling the guidance of a swing arm on center pivot irrigation equipment. For example, GPS based guidance control systems are disclosed in U.S. Pat. Nos. 6,254,018 B1 and 6,290,151 B1 and in pending U.S. patent application Ser. Nos. 10/302,373 and 10/814,829. Such prior patents and applications involve the use of GPS steering control systems that regulate steerable wheels on the support towers of a center pivot swing arm apparatus to steer the swing arm into the corners of a field as the irrigation apparatus circles about the field.

In contrast to these prior art control systems for center pivot swing arm steering, the present invention is designed to control the movement of a linear move irrigation apparatus that traverses a field in a straight line and has boom support towers with nonsteerable drive wheels. Accordingly, such prior art guidance systems are not applicable for use in connection with linear move irrigation apparatus.

### SUMMARY OF THE INVENTION

The present invention is a guidance system for providing control for the movement of a linear move irrigation apparatus having an elongated irrigation boom with one end or the center of the boom connected to a source of supply of water and being supported on movable towers with drive motors. The system includes a base unit that is located at a known position. The base unit includes a first satellite signal receiving means for producing position information representative of a calculated position of the base unit and a comparator means for comparing the known position of the base unit with the calculated position information and then generating an error signal representative of the difference therebetween.

The guidance system further includes a second satellite signal receiving means that is preferably associated with one of the drive towers or the boom for producing corrected position information representative of a calculated position of said drive tower. The corrected position information is provided to a computer processing means for storing position information as to the desired path of travel for said irrigation apparatus and for comparing the corrected position information to said desire path of travel information and producing a drive signal output.

The guidance system of the present invention also has a drive control means that receives the drive signal output and controls the operation of the drive motor on one of the end towers in response to said signal output by turning such drive motor on and off to generally maintain the movement of said drive towers along the desired path of travel.

It is, thus, a primary object of the present invention to provide an improved guidance system for a linear move irrigation apparatus that accurately guides the apparatus along a desired path of travel with the irrigation boom maintained in a straight condition.

A further object of the present invention is to provide a guidance system for a linear move irrigation apparatus that involves the use of global positioning satellite signals for determining the position of the irrigation apparatus and utilizing such signals for developing drive control signals for the drive motors of the boom support towers.

The foregoing and other advantages of the present invention will appear from the following description. In the description, reference is made to the accompanying drawings, which form a part hereof, and in which there is shown by illustration and not of limitation a preferred form in which the invention may be embodied. Such embodiment does not represent the full scope of the invention, but rather the invention may be employed in a variety of other embodiments and reference is made to the claims herein for interpreting the breadth of the invention.

### BRIEF DESCRIPTION OF THE DRAWINGS

FIG. 1 is a top plan view of a linear move irrigation apparatus that is equipped with a guidance system constructed in accordance with a preferred embodiment of the present invention;

FIG. 2 is a block diagram of the logic path for the preferred embodiment of the guidance system of the present invention;

FIG. 3 is a diagrammatic view of the irrigation apparatus of FIG. 1 shown moving straight on course along a desired path of travel;

FIG. 4 is a diagram similar to FIG. 3, but showing the irrigation apparatus as it deviates from the desired path of travel;

FIG. 5 is a diagrammatical view similar to FIG. 3, but showing the irrigation apparatus moving back toward the desired path of travel; and

FIG. 6 is another diagrammatical view similar to FIG. 3, but showing that the irrigation apparatus is returning back to its desired path of travel.

### DETAILED DESCRIPTION OF THE PREFERRED EMBODIMENT

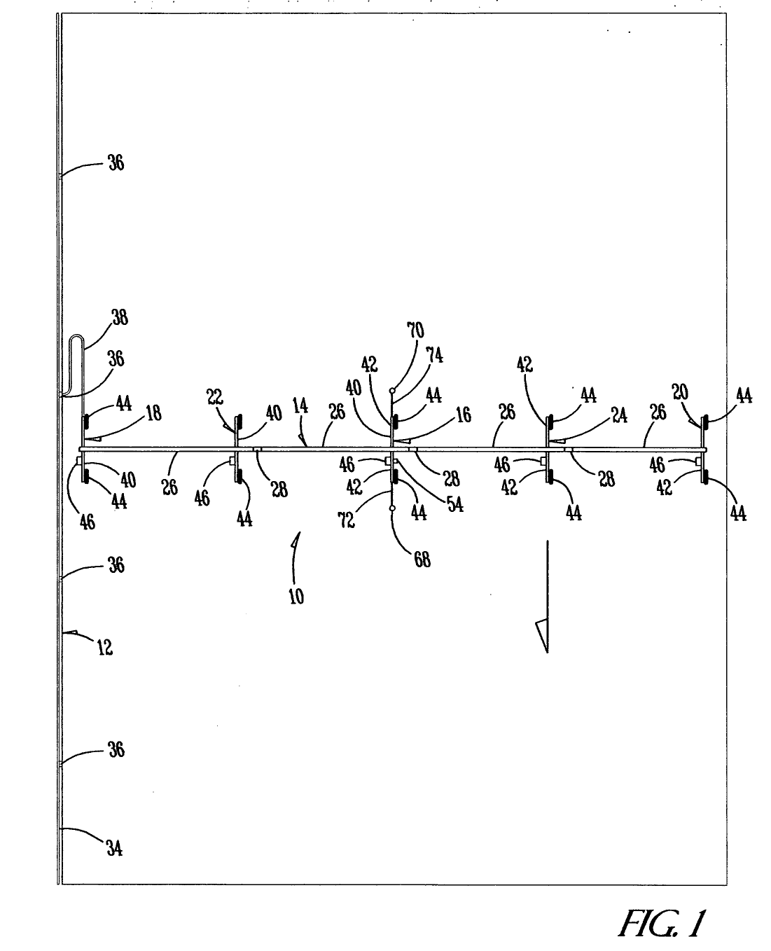

Referring now to the drawings and with reference first to FIG. 1, a linear move irrigation apparatus employing the guidance system of the present invention is generally designated at 10 and is positioned in a rectangular agricultural field 12. The irrigation apparatus is principally formed from an elongated elevated boom 14 that is supported by a plurality of spaced apart drive towers including a center tower 16, end towers 18 and 20 and intermediate towers 22 and 24 located between the center tower and the end towers. The boom 14 is formed of a plurality of elongated pipe sections 26 that are connected end-to-end by flexible couplings 28.

Water can be supplied to the irrigation apparatus in a variety of different ways. For example, as shown in FIG. 1 a water supply pipe 34 extends a long the ground at the side of the field 12 and has a plurality of spaced apart outlets 36 to which one end of a flexible hose 38 may be connected. The hose 38 is attached at its opposite end to one end of the irrigation apparatus 10 to deliver water thereto. The boom 14 includes a plurality of spaced apart sprinklers (not shown) which discharge water to the field 12 in a uniform pattern of distribution as the irrigation apparatus traverses the field. Water is pumped into the supply pipe 34 by a conventional pump (not shown).

The irrigation boom 14 and each of the movable towers 16-24 are constructed in a fashion as is well known in the art and are each formed of an A-shaped frame 40 that includes a pair of downwardly diverging legs 42 with ground engaging, nonsteerable wheels 44 at their lower ends. A conventional electric motor 46 drives the wheels 44 and is reversible in order to propel each of the towers 16-24 in an opposite direction along the field 12. A conventional alignment system (not shown) such as that shown in U.S. Pat. No. 3,608,826 and incorporated herein by reference serves to prevent the intermediate towers 22 and 24 from moving unduly ahead of or lagging behind the end towers 18 and 20. Thus, the boom 14 is maintained in a straight condition at all times by such conventional alignment system. Additional support towers may be provided for longer irrigation booms and a lesser number of towers certainly is also possible. It should be understood that other types of alignment systems can be used and that in some cases no alignment system is necessary.

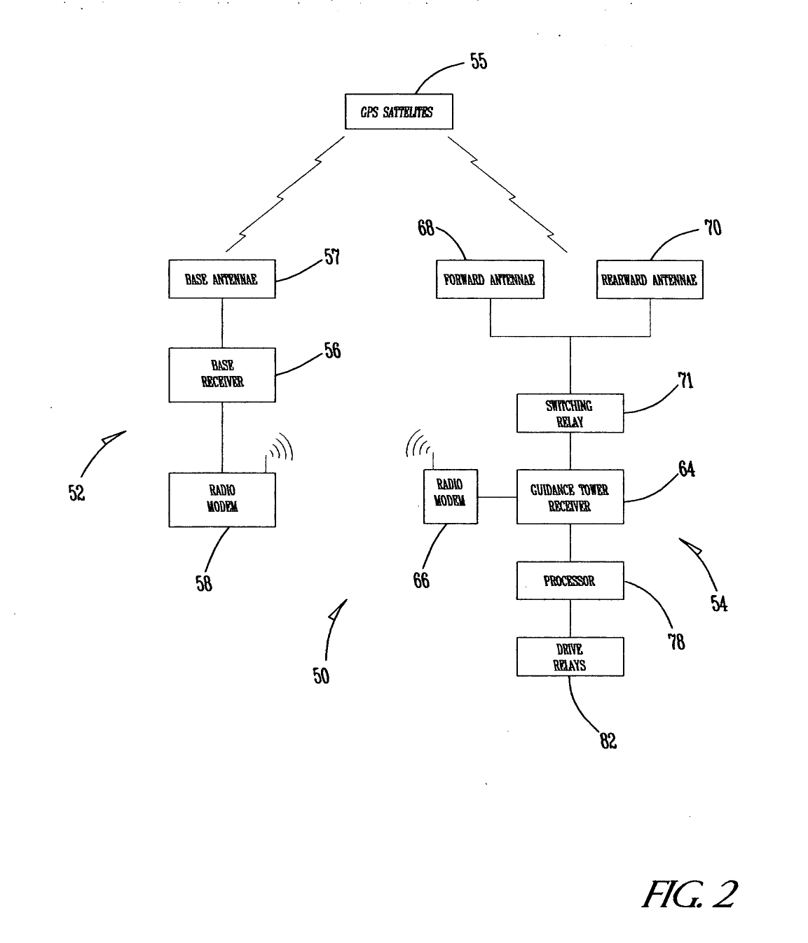

As described above, the irrigation apparatus 10 is adapted to provide water for crops by traversing the field 12 in a straight line generally perpendicular to the boom 14. To provide guidance control for the apparatus 10, the present invention includes an efficient and accurate guidance control system 50 as shown in FIG. 2, that includes a base unit 52 and a tower unit 54. The base unit 52 is adapted to be located at some known fixed location with respect to the field 12 and is maintained in that position during operation of the guidance control system 50. The base unit 52 includes a first satellite signal receiving means 56 that preferably is a Trimble BD750 RTK GPS receiver with a L1/L2 antenna 57. Prior to operation of the system 50 the first signal receiving means 56 is programmed with its exact latitude and longitude coordinates.

The first receiving means 56 is capable of receiving position signals from a number of global positioning satellites, indicated at 55 in FIG. 2, as is well known in the art and generating a correction factor every second based upon a comparison of its programmed known position and that position received through the GPS satellites 55. The correction factor produced by the receiving means 56 is supplied to preferably a radio modem 58, that also forms part of the base unit 52, and transmits the correction factor to the tower unit 54 that is associated preferably with the center tower 16 of the irrigation apparatus 10. The tower unit 54 includes a second satellite signal receiving means 64, similar to the first receiving means 56 and a tower radio modem 66.

The tower modem 66 is on the same frequency as the base modem 58 for receiving the correction factor transmitted thereby. The tower unit 54 generates its position information accordingly, using the correction factor that has been formulated by the receiving means 56 and transmitted by the modem 58 in conjunction with the position information signals received from the GPS satellites. The position information produced by the tower unit 54 is in the form of the longitudinal and latitudinal coordinates of the second receiving means 64 and is accurate to within two centimeters of the true position of such means.

To receive the GPS signals the second receiving means 64 has forward and reverse GPS receiving antennas 68 and 70, respectively, that are preferably mounted on the tower 16 via extension arms 72 and 74, respectively. The extension arms 72 and 74 extend outwardly from the tower 16 approximately five to eight feet in the preferred embodiment so that one of the antennas 68 or 70 always leads the wheels 44 regardless of the direction the system 10 is moving. However, it is important to note that it is not a critical feature of the invention that the extension arms are of such length and they may be shorter if desired and, furthermore they can also be mounted from the boom 14 if such arrangement is convenient.

Only one of the antennas 68 and 70 receives the GPS signals at any given time. This is because a switching relay 71 is utilized to activate the forward antenna 68 when the apparatus 10 is moving in a forward direction and to activate the reverse antenna 70 when the apparatus 10 is moving in a reverse direction.

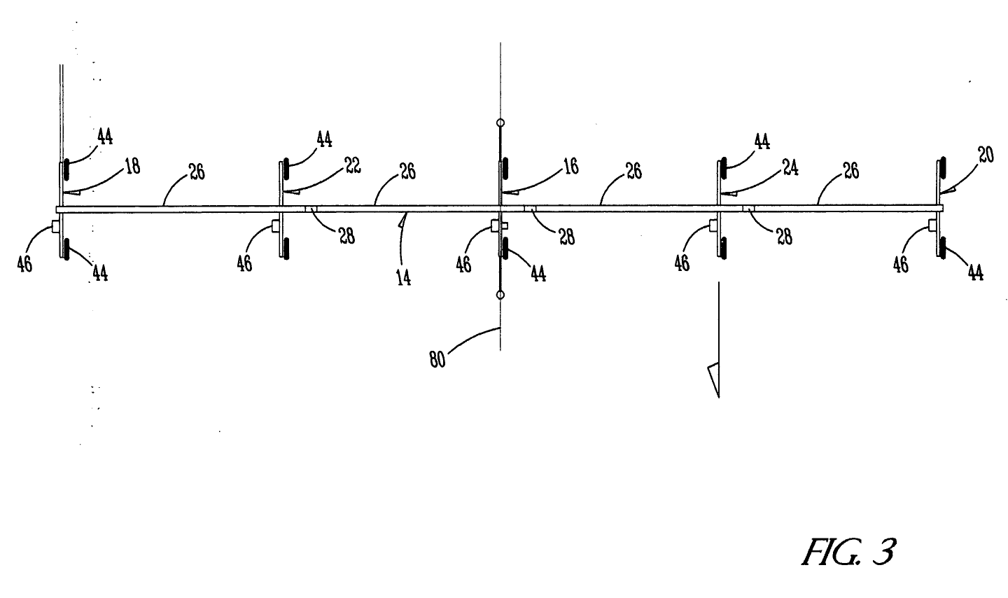

Because of the preferred location of the antennas 68 and 70 leading their associated drive wheels 44, position information utilized by the second signal receiving means 64 does not represent the exact position of the center tower 16. Instead, such information represents a position that is forward or rearward of the boom 14. This relationship is critical to the efficient and improved operation provided by the guidance control system 50 of the present invention by reducing the amount of over shoot that is realized in steering the apparatus 10 along its desired path of travel as indicated by the diagrammatical views of FIGS. 3-6 in which the apparatus 10 is moving in a forward direction.

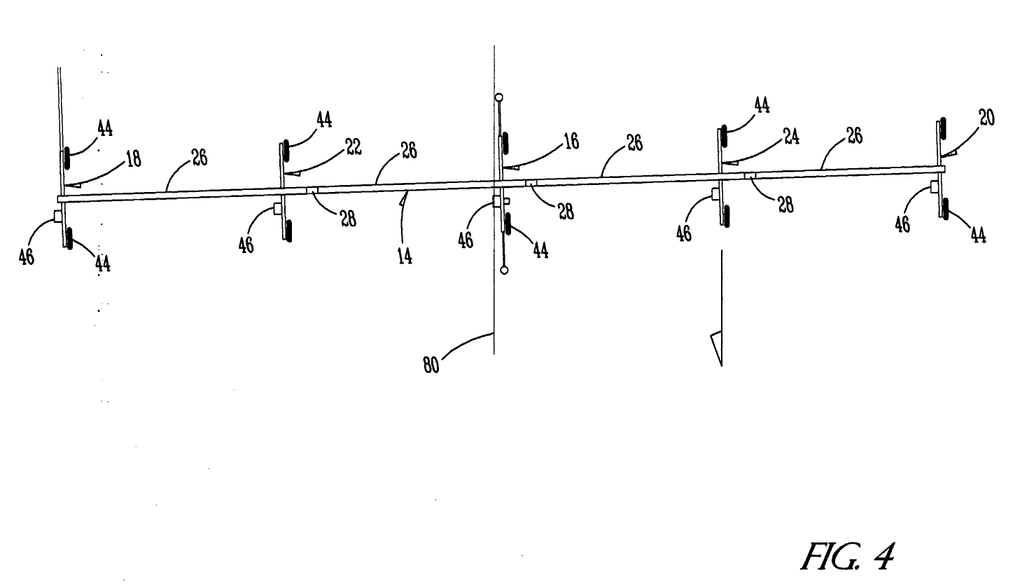

As shown in FIG. 3, when the irrigation apparatus is moving along its desired path of travel the tower drive motors 46 for the towers 16-24 operate concurrently. However, if the apparatus 10 begins to move off its desired path of travel 80 as indicated in FIG. 4, the guidance control system 50 causes the operation of the drive motors 46 to vary, as will be now described.

The position information provided by the second receiving means 64 is provided to a central processing unit 78, that is also preferably located on the center tower 16 and preferably is a 386 computer in PC 104 format. In addition to receiving position information from the second receiving means 56, the CPU 78 stores information representative of the the desired straight line path of travel 80, which path information is produced before the apparatus 10 can be operational. To determine the path of travel 80 the second receiving means must be temporarily located over one of the end points of the path 80 and a record button is then pressed on the CPU 78. Then the opposite end point of the path of travel 80 is recorded in the same manner. Accordingly, a straight line with two end points is all that is required to determine the required path 80.

Upon receiving the position information from the second receiving means 64, the CPU 78 compares such position information to the information stored in memory for the desired path 80. If the antenna 68 moves off the desired path 80 a sufficient distance, more than 0.15 feet, as indicated in FIG. 4, the guidance control system 50 will take action to bring the apparatus 10 back to its proper line of travel.

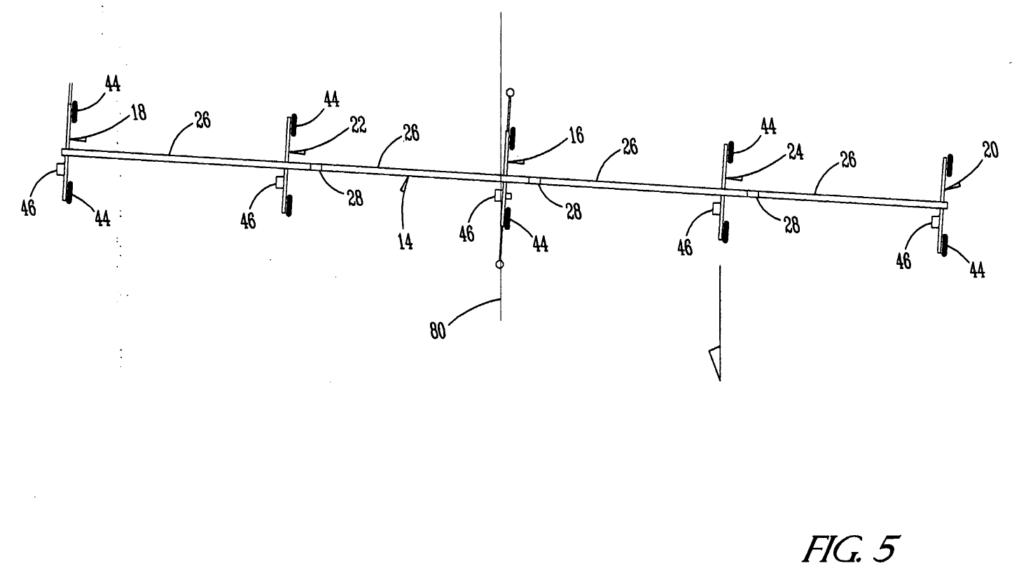

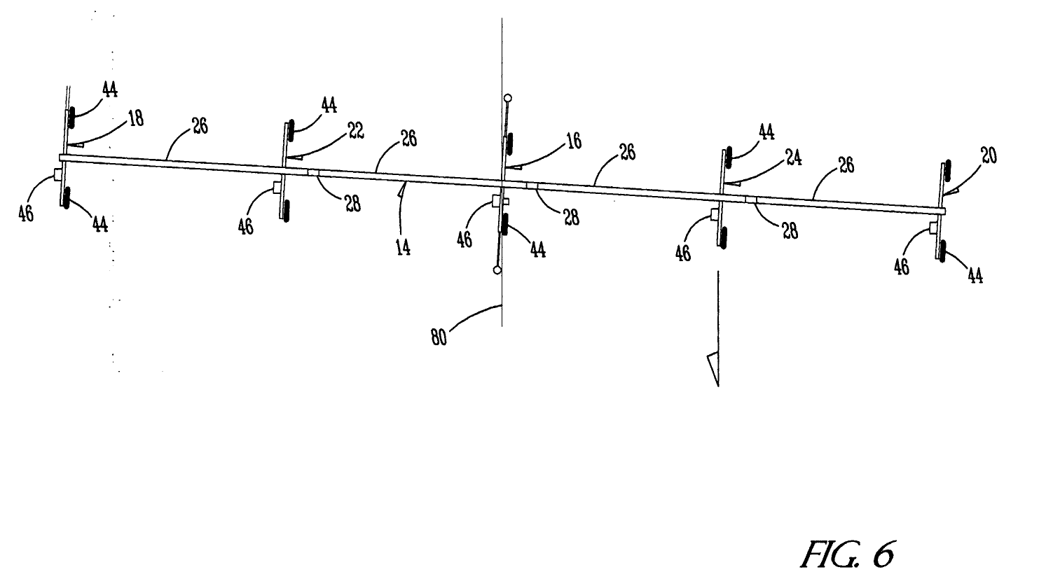

The guidance control 50 accomplishes such action by stopping or slowing down the drive motors 46 for the support towers 18 and 22 on the leading side of the boom 14 and letting the other side move or swing around to reestablish a straight trajectory, as indicated in FIGS. 5 and 6. Such control of the drive motor 46 on the towers 8 and 22 is directly provided to the tower 18 by means of drive relays 82 and a percentage timer, not shown, that times the operation of the motor 46, as is known in the art.

As the tower 18 moves forward, the tower 22 - which is a slave to the tower 18—is driven in correspondence to the movement of the tower 18 as is well-known in the art. Since the forward antenna 68 is leading the wheels 44, the antenna 68 will reach and cross the path of travel 80 before the wheels 44. When the antenna 68 reaches and crosses the path 80, the guidance system 50 again allows the drive motor 46 on the towers 18 and 22 to operate at a faster rate to bring the apparatus 10 back in line with the path of travel 80.

Thus, the present invention provides a novel, efficient and accurate means for controlling the travel of a linear move irrigation apparatus 10. Although the control means of the present invention has been described with respect to a preferred embodiment, it should be understood that such embodiment may be altered without avoid the true spirit and scope of the present invention. For example, the CPU 78 and the drive relays 82 can be combined in a single module if so desired and other modifications to the electronics can be made as should be obvious to those skilled in the art.

What is claimed is:

1. A guidance system for providing movement control of a lateral move irrigation apparatus having an elongated irrigation boom connected to a supply of water and supported on at least two movable towers having drive motors and nonsteerable wheels, said system comprising:
(a) A base unit located at a known position and including:
(1) a first satellite signal receiving means for receiving position information from a plurality of satellites and producing a correction factor representative of the difference between the known position of said base unit and the position information received from said satellites; and;
(2) means for transmitting said correction factor;
(b) an irrigation boom control unit mounted on said irrigation apparatus and including:
(1) means for receiving said correction factor from said transmitting means;
(2) a second satellite receiving means for receiving position information signals from a plurality of satellites and producing corrected position information of said second receiving means based upon the position information signals received from said satellites as modified by said correction factor;
(c) computer processing means for storing position information representative of a desired straight line path of travel of said one of said movable tower and for comparing said corrected position information to said desired path of travel information and producing a drive signal output;
(d) drive control means that receives said drive signal output and controls the operation of the drive motor on one of said movable towers in response to said output by turning the drive motors on and off to generally maintain the movement of said tower along said desired path of travel.

2. The guidance system as described in claim 1, wherein said irrigation boom control unit includes a first GPS receiving antenna associated with said one of said movable towers in a position that is continuously in front of at least one of the tower drive wheels such that the position information received by said second receiving means from said first antenna reflects locations that said one of said drive wheels is moving toward when the tower is moving in a forward direction so that deviations of the drive tower from said predetermined path of travel are minimized.

3. The guidance system as described in claim 2, wherein said second satellite receiving means further includes a second GPS receiving antenna associated with said one of said movable towers in a position to the rear of the drive wheels of said one of said towers such that the position information received by said second receiving means from said second antenna reflects locations that said drive wheels are moving toward when said one of said drive towers is moving in a rearward direction so that deviations of said one of said drive towers from said predetermined path of travel are minimized.

4. The guidance system as described in claim 3, wherein said first and second GPS receiving antennas are mounted on said one of said movable towers by means of support arms in a position approximately four to nine feet from said one of said movable towers.

5. The guidance system as described in claim 1, wherein said drive control means includes drive relays with a percentage timer that times the duration of operation of the drive motors on said movable towers, which timer is regulated by the drive signal output to turn the drive motors for the movable towers on and off for proper guidance of the irrigation apparatus.

6. The guidance system as described in claim 5, wherein said boom control unit includes an antenna relay to select one of said GPS antennas for operation depending on the direction of travel of the irrigation apparatus so that only one of said antennas is operating at any given time.

7. A guidance system for providing movement control of a linear move irrigation apparatus having an elongated irrigation boom connected to a supply of water and supported on at least two movable towers having drive motors and nonsteerable wheels, said system comprising:
(a) a satellite signal receiving means for receiving position information signals from a plurality of satellites and producing position information of said receiving means based upon the position information signals received from said satellite;
(b) computer processing means for storing position information representative of a desired straight line path of travel of said movable towers and for comparing said position information to said desired path of travel information and producing a drive signal output in response; and
(c) drive control means that receives said drive signal output and controls the operation of said drive motor on one of said movable towers in response to said output by turning the drive motor on and off to generally maintain the movement of said drive towers along said desired path of travel.

8. The guidance system as described in claim 7, wherein said GPS signal receiving means includes a first GPS receiving antenna mounted on said one of said movable towers in a position that is continuously in front of at least one of the tower drive wheels such that the position information received by the signal receiving means from said first antenna reflects locations that said one of said drive wheels is moving toward when the tower is moving in a forward direction so that deviations of the drive tower from said predetermined path of travel are minimized.

9. The guidance system as described in claim 8, wherein said satellite signal receiving means further includes a second GPS receiving antenna mounted on said one of said movable towers in a position to the rear of the drive wheels of said one of said towers such that the position information received by said second receiving means from said second antenna reflects locations that said drive wheels are moving toward when said one of said drive towers is moving in a rearward direction so that deviations of said one of said drive towers from said predetermined path of travel are minimized.

10. The guidance system as described in claim 9, wherein said first and second GPS receiving antennas are mounted on support arms in a position approximately four to nine feet from said one of said movable towers.

11. The guidance system as described in claim 10, wherein said drive control means includes drive relays with a percentage timer that times the duration of operation of the drive motors of said movable towers, which timer is regulated by the drive signal output to turn the drive motors for the movable towers on and off for proper guidance of the irrigation apparatus.

12. The guidance system as described in claim 11, wherein said signal receiving means includes an antenna relay to select one of said GPS antennas for operation depending upon the direction of travel of the irrigation apparatus so that only one of said antennas is receiving GPS signals at any given time.
